(19) United States
(12) Patent Application Publication
(10) Pub. No.: US 2024/0278856 A1
(43) Pub. Date: Aug. 22, 2024

(54) LIGHTWEIGHT HIGH-EFFICIENCY COMPOSITE AUTOMOBILE DESIGN FOR PASSENGER AND CARGO APPLICATIONS

(71) Applicants: GAGAN AGRAWAL, vadodara (IN); PRAKHAR AGARWAL, lucknow (IN)

(72) Inventors: GAGAN AGRAWAL, vadodara (IN); PRAKHAR AGARWAL, lucknow (IN)

(21) Appl. No.: 18/238,517

(22) Filed: Aug. 27, 2023

(30) Foreign Application Priority Data
Feb. 20, 2023 (IN) 202311011542

(51) Int. Cl. B62D 29/04; B60L 50/60; B60R 19/22; B60R 19/24; B62D 21/11; B62D 21/15; B62D 25/16

(52) U.S. Cl. CPC B62D 29/046; B60R 19/22; B60R 19/24; B62D 21/11; B62D 21/157; B62D 25/163; B60L 50/60

(57) ABSTRACT

In one aspect, an Battery Electric Vehicle (BEV) system for passenger and cargo applications comprising: a chassis mainframe coupled with a plurality of crash structures; wherein the plurality of crash structures comprises: a front crash structure and a rear crash structure, wherein the front crash structure is attached to the chassis mainframe through a first flanged joint, with a first adhesive bond between one or more flanges and suitable rivets, and wherein a flanged joint butts two beams the plurality of crash structures to provide both a load path for a load transfer from the plurality of crash structures and a base for arresting a crash deformation, wherein the flanged joint enables ease of repair in case of damage to the crash structure, requiring complete replacement of the crash structure.

### CLAIM OF PRIORITY

This application claims priority to Indian Provisional Patent Application no. 202311011542, filed on Feb. 20, 2023, and titled LIGHTWEIGHT HIGH-EFFICIENCY COMPOSITE AUTOMOBILE DESIGN FOR PASSENGER AND CARGO APPLICATIONS. This foreign patent application is incorporated by reference in its entirety.

### BACKGROUND

### 1. Field

Various embodiments of the disclosure relate to a composite light weight electric vehicle design. More specifically, embodiments of the disclosure are related to design of the lightweight electric vehicle that enables improving utility of battery pack leading to improved efficiency and range of the electric vehicle.

### 2. Related Art

Conventionally designed electric vehicles may be inefficient due to multiple factors. For example, such factors may include structural inefficiency, use of multiple moving parts that may be assembled using known conventional techniques, etc., Such factors may thereby lead to increasing the overall weight of the electric vehicle thereby impacting efficiency and performance of the electric vehicle.

Further, other conventional techniques that may include building the electric vehicles using conventional manufacturing materials, for example, metals, alloys, etc., may include high manufacturing complexity, thus increasing the associated costs including the cost the electrical vehicle. The limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

In one aspect, an Battery Electric Vehicle (BEV) system for passenger and cargo applications comprising: a chassis mainframe coupled with a plurality of crash structures; wherein the plurality of crash structures comprises: a front crash structure and a rear crash structure, wherein the front crash structure is attached to the chassis mainframe through a first flanged joint, with a first adhesive bond between one or more flanges and suitable rivets, and wherein a flanged joint butts two beams the plurality of crash structures to provide both a load path for a load transfer from the plurality of crash structures and a base for arresting a crash deformation, wherein the flanged joint enables ease of repair in case of damage to the crash structure, requiring complete replacement of the crash structure.

### BRIEF DESCRIPTION OF THE DRAWINGS

FIG. 1 is an illustration of a chassis mainframe and crash structures, according to an exemplary embodiment.

FIG. 2A is an illustration showing a front crash structure of the BEV, according to an embodiment.

FIG. 2B is an illustration showing a rear crash structure of the BEV, according to an exemplary embodiment.

FIG. 2C is an illustration showing side crash pillars that may be attached to side frames in a cabin of the BEV, according to an exemplary embodiment.

FIG. 3 is an illustration showing an assembly of suspension towers on chassis, according to an exemplary embodiment.

FIG. 4 is an illustration showing a flanged extension of the suspension towers adapted to be fitted on a chassis beam, according to an exemplary embodiment.

FIG. 5A and FIG. 5B are illustrations showing connector bracket assembly for suspension tower to chassis interface, according to an exemplary embodiment.

FIG. 6 is an illustration showing an assembly of a front firewall to a chassis, according to an exemplary embodiment.

FIG. 7A is an illustration showing a body structure including the floor of the BEV, according to an exemplary embodiment.

FIG. 7B is an illustration showing a body structure including two side frames and a top frame of the BEV, according to an exemplary embodiment.

FIG. 8 is an illustration showing an assembly of the body mounting on a chassis, according to an exemplary embodiment.

FIG. 9 is an illustration showing different components or parts of the BEV, according to an exemplary embodiment.

FIG. 10 is an illustration showing a suspension tower chassis connector, according to an exemplary embodiment.

FIG. 11 is an illustration showing a side frame of the chassis including wheel arch connector on a rear side of the BEV, according to an exemplary embodiment.

FIG. 12 is an illustration showing a side frame of the chassis connector, according to an exemplary embodiment.

FIG. 13 is an illustration showing a side frame of the chassis including wheel arch connector on a front side of the BEV, according to an exemplary embodiment.

FIG. 14 is an illustration showing a suspension tower chassis connector on the front side of the BEV, according to an exemplary embodiment.

FIG. 15 is an illustration showing a wheel arch chassis connector on the front side of the BEV, according to an exemplary embodiment.

FIG. 16 is an illustrator showing a front side firewall chassis connector of the BEV, according to an exemplary embodiment.

The Figures described above are a representative set and are not an exhaustive with respect to embodying the invention.

### DESCRIPTION

Disclosed are a system, method, and article of manufacture of lightweight high-efficiency composite automobile design for passenger and cargo applications. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Battery Electric Vehicle (BEV), pure electric vehicle, only-electric vehicle, fully electric vehicle or all-electric vehicle is a type of electric vehicle (EV) that exclusively uses chemical energy stored in rechargeable battery packs, with no secondary source of propulsion (e.g. a hydrogen fuel cell, internal combustion engine, etc.). BEVs use electric motors and motor controllers instead of internal combustion engines (ICEs) for propulsion. They derive all power from battery packs and thus have no internal combustion engine, fuel cell, or fuel tank. BEVs include, inter alia: motorcycles, bicycles, scooters, skateboards, railcars, watercraft, forklifts, buses, trucks, cars, etc.

E-glass can be a glass composition made from the oxides of silicon, aluminum, calcium, magnesium, and boron.

Monocoque is a structural system in which loads are supported by an object's external skin.

Polypropylene (PP), also known as polypropene, is a thermoplastic polymer used in a wide variety of applications. It is produced via chain-growth polymerization from the monomer propylene.

Twintex® reinforcements can be a ready-to-use thermoplastic and glass combination. Twintex® has high-mechanical properties (e.g. stiffness-to-weight ratio and impact properties, etc.). It is noted that other thermoplastic and glass combinations can be used in lieu of Twintex® in other example embodiments.

### Example Embodiments

Embodiments of a method, system, techniques, a device, or an apparatus for manufacturing or building battery electric vehicles (BEV) including a unique design approach that lowers the complexity, manufacturing capabilities and associated costs are described. The subject specification describes use of stable prepreg continuous GFRP composites and commoditized manufacturing methods to build a lightweight electric vehicle structure that significantly lowers the maintenance costs due to minimal repairability requirements. A new design lightweight composite electric vehicle structure is proposed that may be feasible for mass production.

Battery Electric Vehicles (BEV) are an energy constrained system. High efficiency is critical to extracting maximum range out of a battery pack, and in turn to save cost by reducing the battery pack size. Affordable BEVs are a must to large scale electrification and to save manufacturing heavy carbon footprint.

In an embodiment, the subject specification describes a new ground up approach to lightweighting a BEV (passenger or logistics automobile platform) that takes advantage of an end-to-end Thermoplastic Structural Design to extract the maximum advantage from lightweighting. Further, the subject specification describes a new design philosophy for building the Chassis floor, Integrated suspension towers, Front crash structures and integrated A-B-C pillars that allow for affordable manufacturing of a passenger electric vehicle composite monocoque or a Blended Chassis-Cabin-Tray composite structure for a light/heavy commercial vehicle.

In an embodiment, through ground-up lightweighting, design first approach for affordable manufacturing and material selection, the efficiency of a BEV automobile can be increased from 1.8× to 2.5× and translated into more than 40%-60% battery pack savings resulting in a positive cascading effect on weight, range and performance. The tenets of design used for building the composite structure are described in the subject specification, along with the manufacturing and joining techniques.

In an embodiment, the key material used for building the composite parts via compression molding may be a bi-directional Twintex® E-glass fiber with PP resin (and/or other resin mixes). While, for pultruded beams/parts, E-glass fiber may be mixed with multiple thermoplastic resins to yield the required strength. The final parts exhibit tensile strength upwards of 1000 MPa and flexural strength between 450 to 600 MPa. The subject specification describes techniques that include aspects of, for example, design, development, and realization of a passenger EV for high range at competitive cost, through extensive use of composite material in both load bearing and panel structures.

In an embodiment, the subject specification describes techniques to reduce weight that enables improving the energy efficiency of the passenger vehicle. For example, such techniques may include a design and/or use of a full composite structure, including the chassis, body, crash structures, exterior panels, etc. Further techniques may include, for example, pultruded composite beams, joined using suitable composite brackets along with adhesive and/or rivets, to construct the ladder chassis with composite material. Further the subject specification describes specially designed crash structures, with pultruded composite beams for the telescopic construction. Further, techniques described herein may include composite monocoque construction of the Suspension tower along with wheel arch. Further, techniques described herein may include an Integral monocoque side frame for the A, B and/or C pillars, with suitable stiffening using intermittent sandwich construction. Further, the subject specification describes sandwich beam construction for the top frame connecting the two side frames, composite monocoque corrugated panels for cabin floor and front firewall. Further, techniques described herein may include joints constructed with composite brackets, coupled with adhesive and/or rivets.

In an embodiment, further techniques described herein may include reducing weight for energy efficiency of the electric LCV, via, for example, full composite structure, including the chassis, body, crash structures, exterior panels, etc. Further techniques described herein may include pultruded composite beams, joined using suitable composite brackets along with adhesive and/or rivets, to construct the ladder chassis with composite material. Further techniques described herein may include composite monocoque corrugated panels for cabin and/or payload tray construction. Further techniques described herein may include joints constructed with composite brackets, coupled with adhesive and/or rivets.

In an embodiment, the above-described techniques in the subject specification may be used or implemented for manufacturing, for example, Passenger Cars: Sedans and SUVs, which need higher weight and cost efficiencies. Specifically applicable to Electric cars and SUVs, where lowering the battery size without considerable impact on the range of the electric vehicle may be important or vital. Further, non-limiting examples may include transport Trucks (1-2 tonners): Last mile delivery trucks that need higher weight and cost efficiency. Specifically applicable to Electric trucks/wagons/vans, where lowering the upfront costs associated with manufacturing and subsequent maintenance of the electric vehicle may be vital such that the overall or total cost of ownership may be lowered.

In an embodiment, the above-described techniques including the subject matter related to improving range and/or efficiency of electric vehicles may provide benefits or advantages of providing a positive cascading effect on weight, range and performance due to lower mass, lower battery pack weight resulting in higher range and performance. Further improvements or advantages may include high mass reduction due to lightweighting, increasing efficiency by 1.8× to 2.5×. Further improvements or advantages may include decreasing Battery Pack kWh requirement by 40-60%, designing and providing affordable composite manufacturing techniques or processes. Further improvements or advantages may include lower number of parts to assemble as compared to conventional internal combustion engine (ICE) based vehicles.

In an embodiment, the chassis and body of BEV may include an assembly of, for example, a chassis mainframe, suspension towers, Crash Structures, Side Frames, Top Frame, Firewalls, Floor panel, Connectors, etc. The interfaces of these composite parts may be configured and designed for providing, for example, strength, stiffness, durability, crash effectiveness, and integration and/or maintenance feasibility. Besides these parts for the construction of the BEV's body, the body panels may be made of GFRP (with possibility of using both bi-directional fabric and chopped fibers with suitable resin systems), etc.

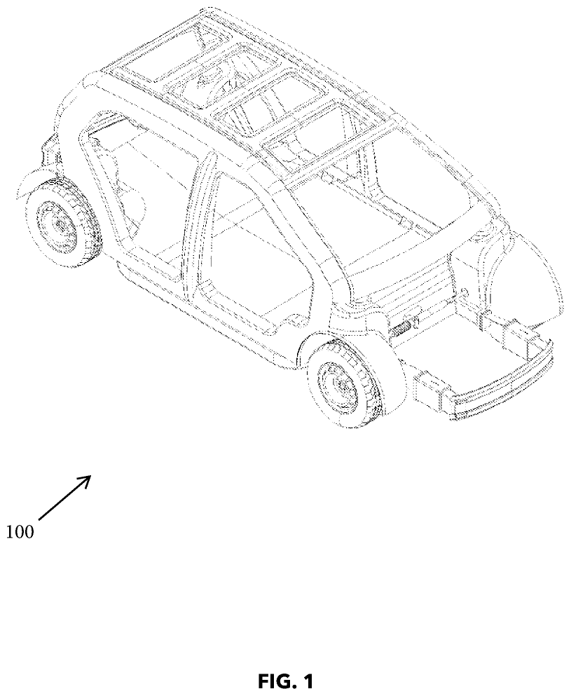

FIG. 1 is an illustration of a chassis mainframe 1000 and crash structures, according to an exemplary embodiment. In an embodiment, FIG. 1 exemplarily illustrates a front crash structure 200 and a rear crash structure 202 (e.g. see infra) that may be adapted to be attached to the chassis mainframe 100 through a flanged joint, with adhesive bond between the flanges and suitable rivets around. The flanged joint butts the two beams to provide both a load path for load transfer from the crash structures and a base for arresting the crash deformation. This joint enables ease of repair in case of damage to the crash structure, requiring complete replacement of the crash structure.

In an embodiment, a load bearing mainframe may be designed and manufactured of composite beams made from pultrusion of a combination of single direction fibers and wrap of woven fabric of the same fiber. The fiber orientation enables major fiber volume fraction in the longitudinal direction, with sufficient transverse direction distribution to handle the shear and torsion loads. The identified pultrusion process provides us the capability to achieve the overall fiber volume fraction of approximately 50% for a chosen thermoplastic resin system. The beams of box, C and I sections of varied thickness are used for construction of the chassis main frame. The chosen combination of material and fabrication process provides the capability to obtain curved sections of the longitudinal beam, which enable reduction of the interfaces. The two main longitudinal beams are curved in-plane near the wheels to house the wheel arches and are connected to each other by cross-beams. In an embodiment, the cross beams of lesser thickness are connected to the longitudinal beams using specially designed sleeved brackets and L-Angles. Each interface uses industrial grade adhesive along with suitable rivets to strengthen the joint for load transfer.

In an embodiment, the chassis mainframe 100 may terminate right after the suspension towers, to support the crash structures. The suspension towers, body monocoque for cabin, the side structures, the front and back crash structures are all directly mounted over this chassis mainframe 100, with suitable interfaces. The attachments to this structure are shaped in order to provide the base surfaces for interfacing with the mounting elements. Each interface may be stiffened and strengthened for smooth load transfer.

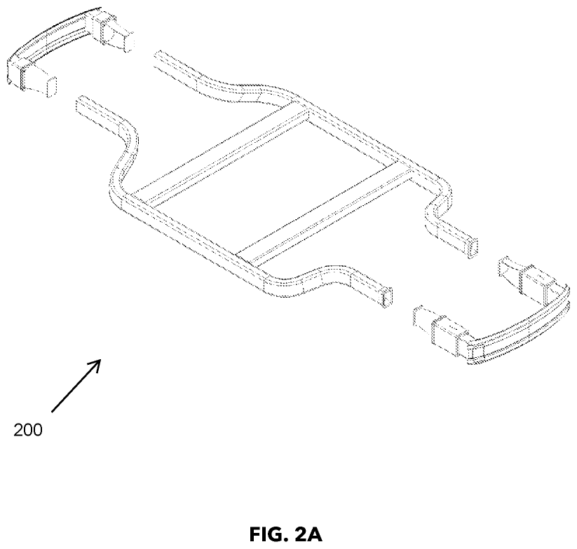

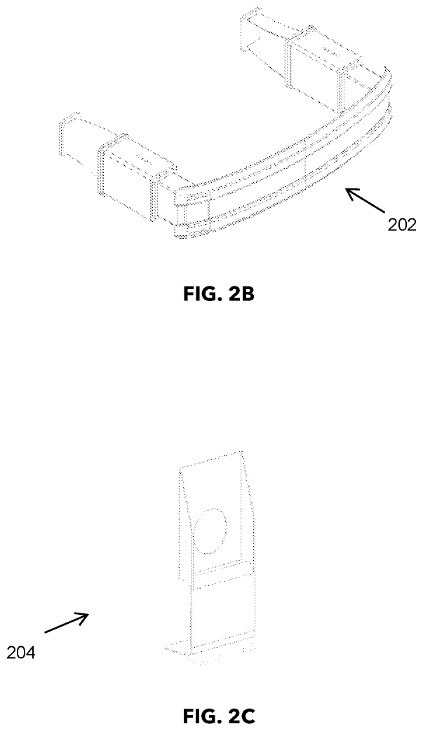

FIG. 2A is an illustration showing a front crash structure 200 of the BEV, according to an embodiment. In an embodiment, FIG. 2 shows the illustration of the front crash structure 200. The front crash structure 200 may be an integral assembly of composite beams to form a U-shaped structure. The longitudinal beams have telescopic construction with embedded foam for absorbing the energy from the crash. Under a crash load, the front bumper beam loads the telescopic tube inwards to crush the foam and then crush the sliding beam itself. The entire crash frame may be mounted on the interface flange from the chassis mainframe 100, after the suspension towers. The two beams are fitted with flanged brackets at the interfacing end for mounting over the chassis mainframe 100. The flanges are mounted using industrial grade adhesive and suitable rivets. This interface enables the ease of mounting during assembly and during the repair work after a crash. The mounting interface on the chassis side may be stiffened more than the crash structure side to ensure that impact energy may be absorbed within the crash structure, with limited distortion behind the chassis interface towards the cabin.

Inherently, composite provides higher energy absorption as compared to metals. In an embodiment, the suspension towers that may be mounted over the beams of the chassis right before the flanged joints of the crash structures. The flange extension behind the suspension tower may be adapted to be fitted on the top face of the chassis beam. It may be bonded and fastened to the beam using blind rivets. Further, from the inner side of the suspension tower, a connector clip may be provided to strengthen the joint. Top part of the connector clip butts with the inner portion of the suspension tower, while the bottom part fits over the beam. The vertical faces of the connector click are fastened using blind rivets for load transfer.

FIG. 2B is an illustration showing a rear crash structure 202 of the BEV, according to an exemplary embodiment. In an embodiment, the rear crash structure 202 may be identical to the front crash structure 200 in its construction, except that the length of the crash beams are shorter.

FIG. 2C is an illustration showing side crash pillars 204 that may be attached to side frames in a cabin of the BEV, according to an exemplary embodiment. In an embodiment, Side frame may include Side Crash pillars 204 (A, B and C). For instance, the side crash pillars 204 may include an assembly of the pillars that may be constructed using one mold using compression molding method. The base material used may be bidirectional continuous E-glass fabric embedded with resin in 60-40% fiber-resin ratio.

In an embodiment, the frame edges have flanges to provide the interface surfaces for the mating parts: a C-shaped flanged extension on the bottom side for the mounting on the chassis beams, a flat flange extension for interfacing with top frame. For extreme side crash safety requirements, the same assembly would be made out of a carbon fiber prepreg impregnated with epoxy resin using the same mold and manufacturing method.

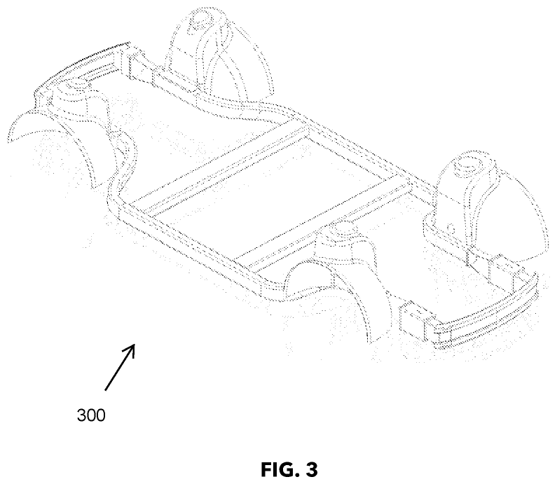

FIG. 3 is an illustration showing an assembly of suspension towers 300 on chassis, according to an exemplary embodiment. In an embodiment, the entire suspension tower may be a monocoque construction of composite, which may be stiffened through shape corrugation during the compression molding itself. The two front suspension towers 300 are also cross connected using an overhead beam to stiffen and strengthen the assembly. A similar construction may be used for the rear set of suspension towers. The base of each suspension tower may be directly mounted over the chassis mainframe 100 for direct load transfer. The base flanges of the suspension tower are mounted over the flange of the chassis beam, using adhesive and suitable fasteners.

In an embodiment, being a complete glass-fiber reinforced plastic (GFRP) construction, it not only reduces the mass, but it also provides additional damping as compared to metals. In case of damage during a crash, the structure could either be patched with GFRP to repair the damage or the entire suspension tower could simply be replaced with a new one. The suspension tower can be a combination of both 2D overfire and chopped fiber, to derive the required strengths and enhanced damping.

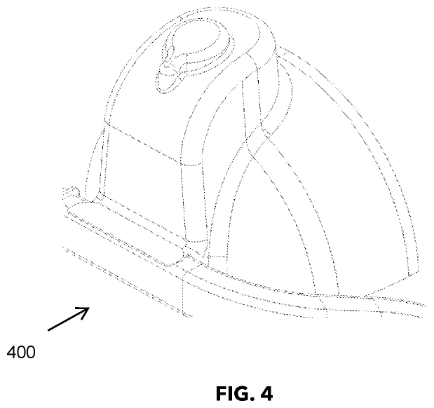

FIG. 4 is an illustration showing a flanged extension 400 of the suspension towers 300 adapted to be fitted on a chassis beam, according to an exemplary embodiment.

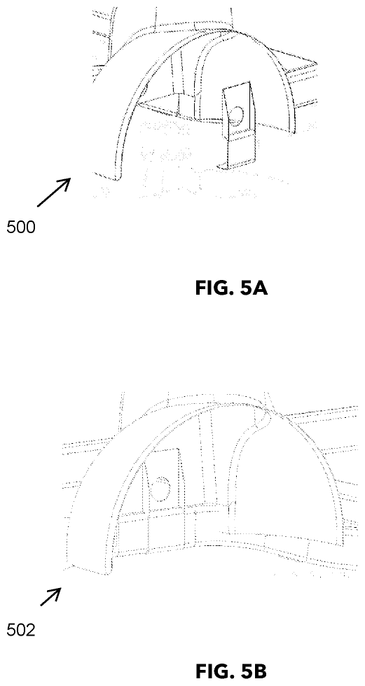

FIG. 5A and FIG. 5B are illustrations showing connector bracket assembly 500 and 502 for suspension tower to chassis interface, according to an exemplary embodiment. In an embodiment, for various interconnections between different monocoque parts and chassis, different kinds of connecting brackets are constructed out CFRP. Each type of connector bracket has a unique mold for layup and curing of prepreg. These monocoque brackets have stiffener flanges on either side to provide the required joint stiffness and strength. The brackets may have extended curved flange for the zone where it may be supposed to sit over the beam of chassis. This configuration provides the capability to handle the shear and moment loads and transfer the longitudinal loads effectively. The thickness of the bracket suits the smooth stiffness transitions.

In an embodiment, the connector brackets for chassis to side frame interface may be mounted on the chassis in their corresponding locations. Each of these may be bonded using adhesive and fastened with suitable rivets to strengthen the joints.

In an embodiment, the shaped panel for the floor may be positioned and guided over the chassis assembly using the reliefs made for the connectors to seat the floor panel over the beam structure. The seat flanges of the floor panel are bonded and riveted to the beams at suitable locations.

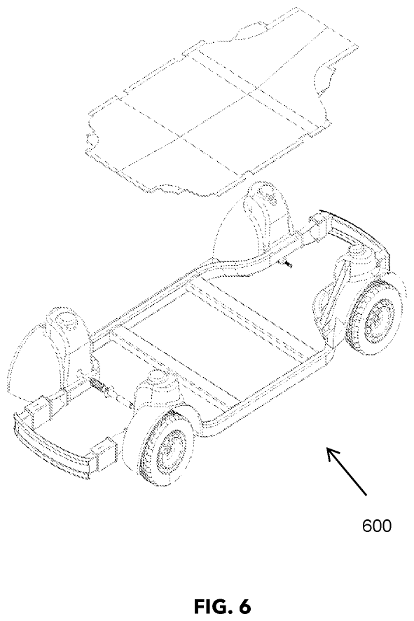

FIG. 6 is an illustration showing an assembly 600 of a front firewall to a chassis, according to an exemplary embodiment. In an embodiment, FIG. 6 shows an illustration of an assembly 600 of a front firewall to a chassis. The firewall panel may be also assembled into position with mating reliefs to guide and hold the assembly. The panel may be connected to the top portion of the suspension tower at the top, and to the chassis at the bottom. The mating connectors provide the interface for holding the front firewall panel in position, with bolts mounted into the metallic inserts, which are pre-bonded in each of the interfacing surfaces. This type of assembly enables repeated assembly and disassembly with ease.

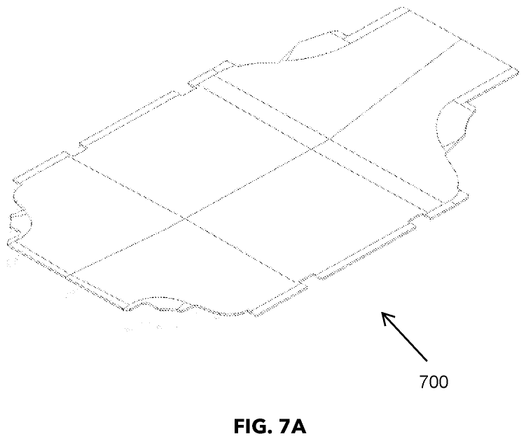

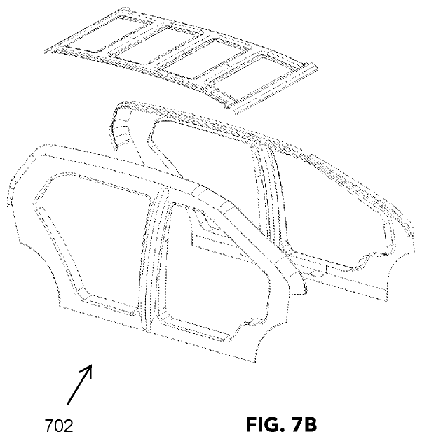

FIG. 7A is an illustration showing a body structure 700 including the floor of the BEV, according to an exemplary embodiment. In an embodiment, the floor panel may be a monocoque construction of either 2D woven glass prepreg or random long glass fiber in thermoplastic resin system. It may be provided with corrugations to provide the required stiffness and may be flat in the zones of the interfacing beams. It also has extended flanges to be bonded over the beams of the chassis, while these flanges have the required reliefs for the connector brackets. This panel may be provided with GFRP, PEEK and metallic inserts for various mountings.

FIG. 7B is an illustration showing a body structure 702 including two side frames and a top frame of the BEV, according to an exemplary embodiment. In an embodiment, the top frame may be a shaped ladder configuration. It may be a monocoque construction with beam sections having sandwich construction for stiffness. The side edges of the frame have flanged extensions for interfacing with the side frames, and the front and rear cross beams provide the interface for direct mounting of the windshield glass. The configuration of the top frame enables ease of integration with side frames and also for mounting the roof panels or sky roof. The structure may be suitably curved to form the profile of the BEV. The configuration also provides stiffness to the body. The entire top frame may be fabricated using layup and curing over a single mold.

Body may be a construction made by assembly of three large structures, vis-a-viz two side frames and a top frame. Longitudinal edges of the side frames and top frame have shaped flanged extensions to provide an overlap joint. The top frame sits over the two side frames. The side frames are butted against the side edges of the flange of the top frame. The continuous seating of the flange of top frame over the flange of side frame, along with the side restriction, provides a stable interface between the frames, forming a boxed construction for the body.

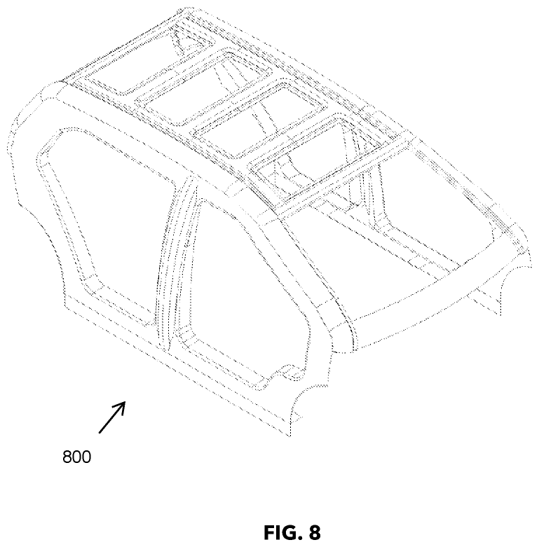

FIG. 8 is an illustration showing an assembly 800 of the body mounting on chassis, according to an exemplary embodiment. In an embodiment, the body may be mounted on the chassis by seating the extended bent flange of the side frame over the chassis beams. The side faces of the connectors previously mounted on the chassis butt against the walls of side frames, where they are bonded and riveted.

FIG. 9 is an illustration showing different components or parts 900 of the BEV, according to an exemplary embodiment.

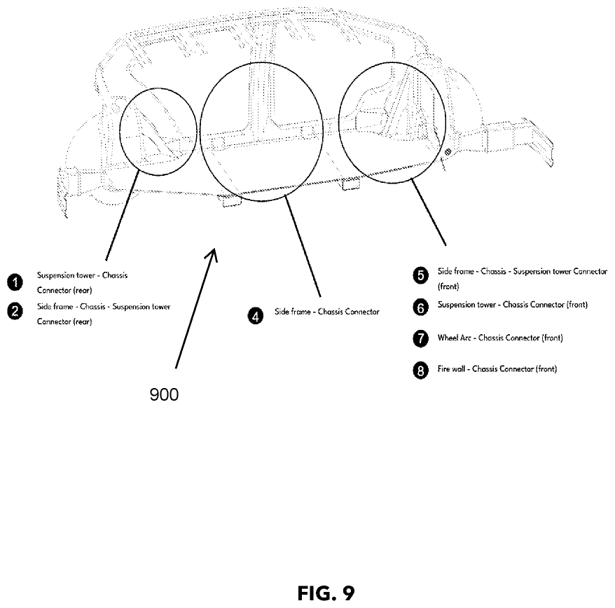

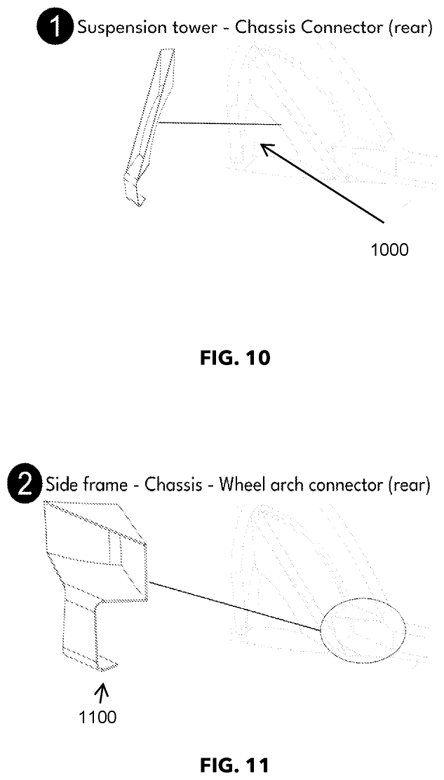

FIG. 10 is an illustration showing a suspension tower chassis connector 1000, according to an exemplary embodiment.

FIG. 11 is an illustration showing a side frame of the chassis including wheel arch connector 1100 on a rear side of the BEV, according to an exemplary embodiment.

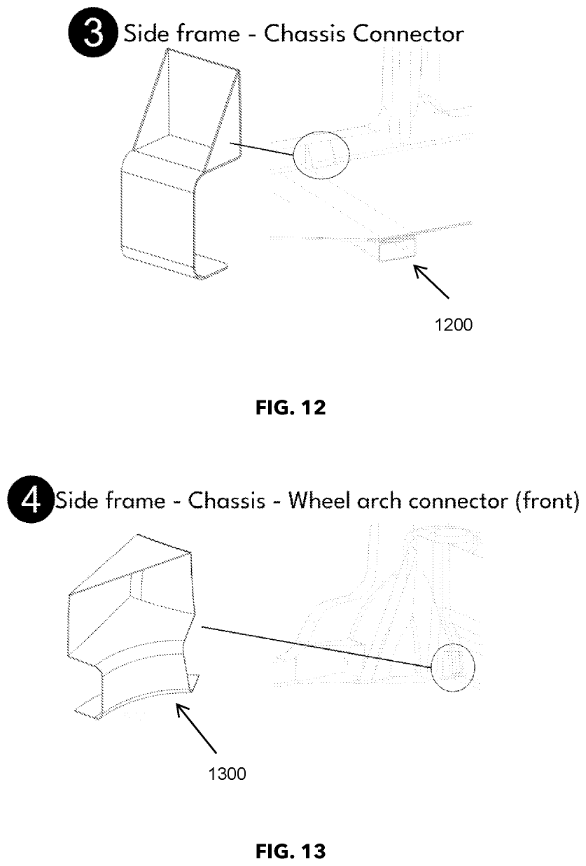

FIG. 12 is an illustration showing a side frame of the chassis connector 1200, according to an exemplary embodiment.

FIG. 13 is an illustration showing a side frame 1300 of the chassis including wheel arch connector on a front side of the BEV, according to an exemplary embodiment.

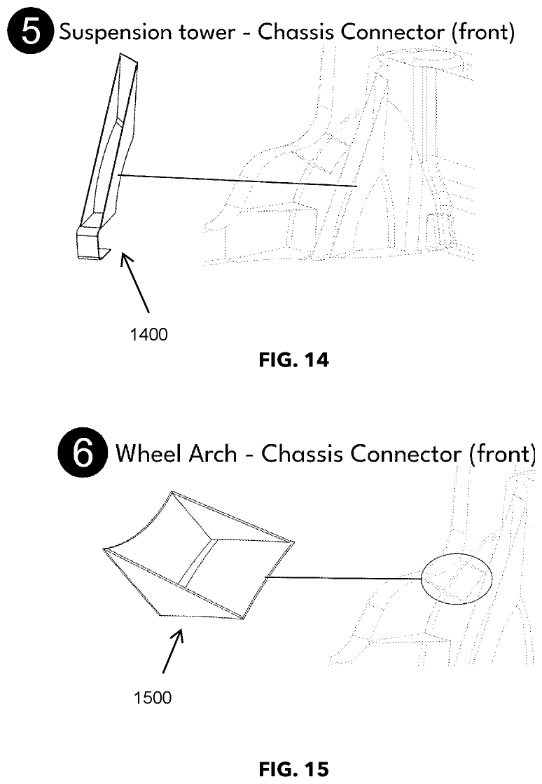

FIG. 14 is an illustration showing a suspension tower chassis connector 1400 on the front side of the BEV, according to an exemplary embodiment.

FIG. 15 is an illustration showing a wheel arch chassis connector 1500 on the front side of the BEV, according to an exemplary embodiment.

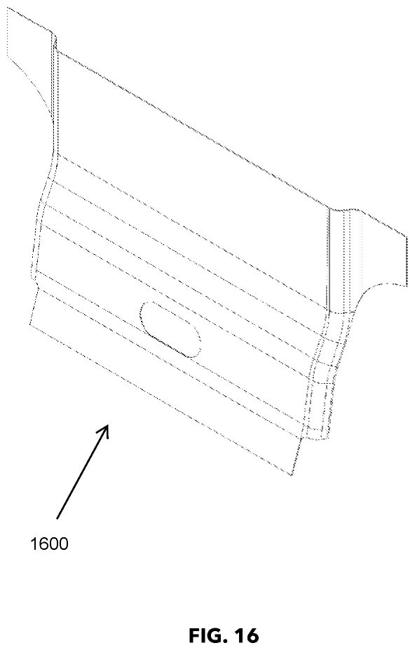

FIG. 16 is an illustrator showing a front side firewall chassis connector 1600 of the BEV, according to an exemplary embodiment. In an embodiment, the front side firewall chassis connect to the floor panel. The front firewall may be a monocoque GFRP construction from either long random glass fiber or 2D woven fabric layup with thermoplastic resin. This may be also stiffened through corrugation patterns and has flanged extension for creating the required interface with chassis and suspension towers. It may be provided with locally stiffened cut outs for routing the steering rod, thermal tubes and cables, etc. Various inserts are bonded to provide the interfaces for mountings.

In an embodiment, the assembly of the electric vehicle body and chassis may be completed, providing a sturdy body for the electric vehicle with significantly reduced weight and augmented crash safety, durability and improvised NVH performance, given the better damping characteristics of composites as compared to metals.

In an embodiment, each of the above-described parts and or components may include either multi-layer custom lay-ups of plain/satin weave glass fabrics or chopped long glass fiber, interwoven with thermoplastic resin fibers are used. This significantly reduces the storage and handling concerns, which are otherwise critical for most of the prepregs. Pultrusion of interwoven glass fabric for beams would use custom dies for the fabrication of the designed beams and cross beams, while custom molds would be used for pressure curing of the parts. Mixing with a set of fillers in the lay-up provides the capability of altering the rendered color of the realized part, giving flexibility to use the body parts directly as exterior of the electric vehicle. The surface finish of the cured parts may be based on the mold surface and can be repeatedly obtained. These set of capabilities of color variation and surface finish, result in a major advantage of fabricating the body panels as well with the same material and process. Thus, also providing coherence and stability in interfaces.

Deriving the specific strength and stiffness from the material choice of GFRP coupled with reliable manufacturing processes for parts fabrication and integration renders the overall design of the chassis and body of the electric vehicle to significantly augment the performance of the EV.

One or more embodiments are now described with reference to the drawings, wherein like reference numerals are used to refer to like elements throughout. In the following description, for purposes of explanation, numerous specific details are set forth to provide a thorough understanding of the various embodiments. It may be evident, however, that the various embodiments can be practiced without these specific details (and without applying to any networked environment or standard).

As described in the subject specification, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As a example, a component may be, but may be not limited to being, a process running on a processor, a processor, an object, an executable, a thread of execution, computer-executable instructions, a program, and/or a computer. By way of illustration and not limitation, both an application running on a server and the server can be a component.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made considering the above detailed description. Rather, the scope is to be determined by the following claims, which are to be interpreted in accordance with established doctrines of claim construction.

Embodiments including techniques, processes, system, components and parts associated with manufacturing a battery electric vehicle (BEV), are described. In one aspect, the subject specification describes lightweighting a BEV (passenger or logistics automobile platform) that takes advantage of an end-to-end Thermoplastic Structural Design to extract the maximum advantage from lightweighting. Through ground-up lightweighting, design first approach for affordable manufacturing and material selection, the efficiency of a BEV automobile may be increased from 1.8× to 2.5× that may enable translating into more than 40%-60% battery pack savings resulting in a positive cascading effect on weight, range and performance.

### CONCLUSION

Although the present embodiments have been described with reference to specific example embodiments, various modifications and changes can be made to these embodiments without departing from the broader spirit and scope of the various embodiments. Accordingly, the specification and drawings are to be regarded in an illustrative rather than a restrictive sense.

What is claimed as new and desired to be protected by Letters Patent of the United States is:

1. A Battery Electric Vehicle (BEV) system for passenger and cargo applications comprising:
a chassis mainframe coupled with a plurality of crash structures;
wherein the plurality of crash structures comprises:
a front crash structure and a rear crash structure, wherein the front crash structure is attached to the chassis mainframe through a first flanged joint, with a first adhesive bond between one or more flanges and suitable rivets, and
wherein a flanged joint butts two beams the plurality of crash structures to provide both a load path for a load transfer from the plurality of crash structures and a base for arresting a crash deformation, wherein the flanged joint enables ease of repair in case of damage to the crash structure, requiring complete replacement of the crash structure.

2. The BEV system of claim 1, wherein the flanged joint enables ease of repair in case of damage to the crash structure, requiring complete replacement of the crash structure.

3. The BEV system of claim 1, wherein the chassis mainframe comprises a load bearing mainframe of composite beams made from a pultrusion of a combination of a plurality of single direction fibers and wrap of woven fabric of the same fiber.

4. The BEV system of claim 3, wherein the fiber orientation provides a major fiber volume fraction in the longitudinal direction, with sufficient transverse direction distribution to handle the shear and torsion loads.

5. The BEV system of claim 4, wherein the identified pultrusion process provides an overall fiber volume fraction of approximately fifty percent (50%) for a chosen thermoplastic resin system.

6. The automobile system of claim 5, wherein the beams of box, C and I sections of varied thickness are used for construction of the chassis main frame.

7. The BEV system of claim 1, wherein the chassis mainframe terminates after one or more suspension towers to support the front crash structure and the rear crash structure.

8. The BEV system of claim 2, wherein the one or more suspension towers, a body monocoque for a cabin, a plurality of side structures, the front crash structure and the rear crash structure are all directly mounted over the chassis mainframe.

9. The BEV system of claim 3, wherein a plurality of attachments to the chassis mainframe are shaped in order to provide the base surfaces for interfacing with the mounting elements, and wherein each interface of the plurality of attachments is stiffened and strengthened for a smooth load transfer.

10. The BEV system of claim 9, wherein the front crash structure comprises an assembly of composite beams to form a U-shaped structure, wherein the front crash structure comprises a set of longitudinal beams comprising a telescopic construction with an embedded foam for absorbing the energy.

11. The BEV system of claim 10, wherein a length of the crash beams of the rear crash structure are shorter than another length of the set of crash beams of the front crash structure.

12. The BEV system of claim 11 further comprising:
a plurality of side crash pillars attached to one or more side frames in a cabin of the BEV, according to an exemplary embodiment.

13. The BEV system of claim 12, wherein a side frame comprises the plurality of Side Crash pillars.

14. The BEV system of claim 13, wherein the side crash pillars comprise an assembly of pillars constructed using one mold using compression molding method, and wherein a base material the side crash pillars comprises a bidirectional continuous E-glass fabric embedded with resin in 60-40% fiber-resin ratio.

15. The BEV system of claim 14, wherein the chassis mainframe further comprises an assembly of suspension towers.

16. The BEV system of claim 15, wherein the assembly of suspension towers comprises a monocoque construction of a composite stiffened through a shape corrugation processing in a compression molding.

17. The BEV system of claim 16, wherein two front suspension towers of the assembly of suspension towers are cross connected using an overhead beam to stiffen and strengthen the assembly of suspension towers.

18. The BEV system of claim 17, wherein a connector bracket assembly is used for each suspension tower to chassis interface between the assembly of suspension towers and the chassis mainframe.

19. The BEV system of claim 1, wherein the BEV system comprises an end-to-end Thermoplastic Structural Design.
